(19) United States
(12) Patent Application Publication
(10) Pub. No.: US 2023/0296815 A1
(43) Pub. Date: Sep. 21, 2023

(54) FLUORESCENT AMPLIFICATION DEVICE USING SURFACE PLASMON RESONANCE AND OPTICAL AMPLIFICATION DEVICE USING SAME

(71) Applicant: GACHON UNIVERSITY OF INDUSTRY-ACADEMIC, Seongnam-si (KR)

(72) Inventor: Heong Kyu JU, Yongin-si (KR)

(73) Assignee: GACHON UNIVERSITY OF INDUSTRY-ACADEMIC COOPERATION FOUNDATION, Seongnam-si (KR)

(21) Appl. No.: 18/015,066

(22) PCT Filed: Oct. 8, 2020
(86) PCT No.: PCT/KR2020/013766

§ 371 Date: Jan. 8, 2023

(30) Foreign Application Priority Data
Jul. 8, 2020 (KR) 10-2020-0083813
Jul. 8, 2020 (KR) 10-2020-0083816

(51) Int. Cl. G02B 5/00; G02B 5/20; G02B 19/00; H01S 3/063; H01S 3/0933; G01N 21/64

(52) U.S. Cl. CPC G02B 5/008; G01N 21/648; G02B 5/205; G02B 19/0009; G02B 19/0085; H01S 3/063; H01S 3/0933; G01N 2021/6471; G01N 2021/6478

(57) ABSTRACT

Disclosed is a light amplifier device comprising a light source emitting a first light; a first lens unit formed under the light source to collect the first light in an opposite direction from the light source; a first filter unit formed under the first lens unit to remove a noise of the first light; an amplifier unit receiving the first light to induce surface plasmon effect and generate second light which is an amplified light; a second filter unit consisted to remove a noise of the second light; and a measurement unit formed in a traveling direction of the second light transmitted through the second lens unit to measure intensity of the second light.

### CROSS-REFERENCE TO RELATED APPLICATIONS

This application is a continuation of International Application No. PCT/KR2020/013766 filed on Oct. 08, 2020, which claims priority from Korean Patent Application No. 10-2020-0083813 filed with Korean Intellectual Property Office on Jul. 08, 2020, and Korean Patent Application No. 10-2020-0083816 filed with Korean Intellectual Property Office on Jul. 08, 2020, the entire contents of which are incorporated herein by reference.

### BACKGROUND

### 1. Field

The inventive concepts relate to a fluorescence amplifier device using surface plasmon resonance, more particularly, to a fluorescence amplifier device which amplifies fluorescent light generated from fluorescent materials using surface plasmon resonance.

And, the inventive concepts relate to a light amplifier device using surface plasmon resonance, more particularly, to an amplifier device which amplifies an incident light using surface plasmon resonance.

### 2. Description of Related Art

In the present, a fluorescent light is used in a various field such as medical diagnostics, bio material labels, a light source of fluorescent tube, an imaging, research for semiconductor and organic/inorganic properties, a cosmic ray detection, mineralogizes, environmental observations, etc.

A conventional fluorescent method, however, applied to these various fields is using a ultra violet light or a blue light series in visible light band with short wavelength as an excitation light source, and then undesirable autofluorescence may be occurred to a slide glass, water or other organic/inorganic materials. The autofluorescence has a problem to deteriorate a signal-to-noise ratio of the fluorescent light.

In case of using a fluorescent dye at high concentration or a strong excitation light, a photo-blenching effect occurred by interaction between excited molecules of fluorescent light causes a photo-degradation because fluorescent molecules are at an unstable optical state.

In addition, a signal of the fluorescent light radiated from the fluorescent molecules is collected using a light collector (objective lens with high aberration or aspherical lens) and collection efficiency is typically at about 1%. Therefore, high expensive photoelectron detector such as a photo multiplier tube (PMT) with detection signal amplification technology should be used when a micro target is detected such as multi-channel analysis using blood.

### SUMMARY

In order to solve the problems of the conventional art, an embodiment of the inventive concept provides a fluorescence amplifier device using surface plasmon resonance which amplifies fluorescent signals by using surface plasmon effect to measure fluorescent light with high sensitivity.

Further, an embodiment of the inventive concept provides a light amplifier device using a surface plasmon resonance which amplifies fluorescent signals by using the surface plasmon resonance to measure fluorescent light with high sensitivity.

In order to solve the problems of the conventional art, an embodiment of the inventive concept provides a fluorescence amplifier device using a surface plasmon resonance. The fluorescence amplifier device using the surface plasmon resonance may be formed to include a light source emitting a first light; a first filter unit; a fluorescence amplifier unit receiving the first light to form a fluorescent light and amplifying the fluorescent light using surface plasmon resonance to form a second light; a second filter unit removing a noise of the second light; a lens unit collecting the second light in an direction; and a measurement unit measuring the second light to measure amount of the fluorescent light.

The light source may be formed of a LED emitting a first light with a mean value of 470 nm.

The first filter unit may be formed in order to remove a first noise which is the noise of the first light with an error over 10 nm on the basis of the first light of 470 nm.

The fluorescence amplifier unit may be formed to include a fluorescent layer formed to include a fluorescent material; a nonconducting layer formed under the fluorescent layer; a plated layer formed under the nonconducting layer; and a dielectric layer formed under the plated layer.

The fluorescent layer may be formed of mixing the fluorescent material to a SiO₂ solution (Telos) and performing a spin-coating on the nonconducting layer.

The fluorescent layer may be formed to include a plurality of silver (Ag) nanoparticle with a diameter under 100 nm.

The fluorescent layer may be formed to have a thickness of 170 nm to 240 nm.

The silver nanoparticle may receive the first light to generate scattered light such that a local plasmon resonance effect is generated.

The fluorescent material may be formed of Rho110.

The nonconducting layer may be formed of a magnesium fluoride (MgF₂) at thickness of 100 nm.

The plated layer may be formed of a silver (Ag) at thickness of 50 nm.

The dielectric layer may be formed of transparent glass in order to transmit the second light.

The fluorescence amplifier unit may use the fluorescent layer and the nonconducting layer as a light waveguide in order to generate the surface plasmon resonance.

The fluorescence amplifier unit may use the local surface plasmon resonance and the surface plasmon resonance to generate the second light which is amplified fluorescent light transformed from the first light.

The second filter unit may be formed in order to remove a second noise which is the noise of the second light with an error over 10 nm on the basis of the second light of 525 nm.

The lens unit may be formed of a compound lens or an aspherical convex lens.

In order to solve the problems of the conventional art, an embodiment of the inventive concept provides a light amplifier device using a surface plasmon resonance. The light amplifier device may include a light source emitting a first light; a first lens unit formed under the light source to collect the first light in an opposite direction from the light source; a first filter unit formed under the first lens unit to remove a noise of the first light; an amplifier unit receiving the first light to induce surface plasmon effect and generate second light which is an amplified light; a second filter unit consisted to remove a noise of the second light; and a measurement unit formed in a traveling direction of the second light transmitted through the second lens unit to measure intensity of the second light, and the amplifier unit may be formed to include a dielectric layer formed of glass; a first plated layer formed of chrome on the dielectric layer; a light waveguide layer formed of silver on the first dielectric layer; and a fluorescent layer formed of fluorescent substance contained in a material capable of coupling with the second plated layer, and formed in a L-mode or P-mode depending on the traveling direction of the second light.

In the L-mode, the traveling direction of the second light is a lateral direction of the amplifier unit, and the second lens unit, the second filter unit and the measurement unit may be successively formed in the lateral direction.

In the P-mode, another surface not an oblique plane of a prism is coupled to a bottom surface of the amplifier unit, the traveling direction of the second light is a direction of the oblique plane of the prism, and the second lens unit, the second filter unit and the measurement unit may be successively formed in the direction of the oblique plane.

The fluorescent layer may be formed by coupling an antibody of Troponin I(Toni) with the second plated layer for two times and coupling the Troponin I containing the fluorescent substance with a secondary antibody of the Troponin I.

The first plated layer may be formed at around 2 nm, the light waveguide layer may be formed at around 50 nm, and the second plated layer may be formed at around 2 nm.

The first light may be emitted from the light source which is formed of an LED and formed with mean wavelength value of 470 nm, and the second light may be emitted from the amplifier unit and formed with mean wavelength value of 525 nm.

The first filter unit may be formed to decide the wavelength out of range of 450 nm to 490 nm as a noise to remove the noise of the first light.

The second filter unit may be formed to decide the wavelength out of range of 500 nm to 550 nm as a noise to remove the noise of the second light.

The first lens unit may be formed of a collimate lens of which a surface is formed in a convex surface to concentrate the first light at a focus point.

The second lens unit may be formed of a convex lens which concentrates the second light in a direction.

An aperture unit may be further included between the first filter unit and the amplifier unit to adjust light amount of the first light of which the first noise is removed.

An ND filter unit may be further included between the second filter unit and the measurement unit to filter collectively light amount of the second light of which the second noise is removed.

The amplifier unit may further include a silicon additive layer (Polydimethylsiloxane, PDMS) under the dielectric layer, the silicon additive is formed using a material which is formed in shape of a plurality of pyramids and has dielectric constant between 1.35 and 1.45.

The P-mode may use immersion oil in order to couple the prism with the measurement unit.

The fluorescence amplifier device using surface plasmon resonance according to an embodiment of the inventive concept may amplify the fluorescent light generated from the fluorescent material such that a measurement sensor can measure fluorescent light more than the conventional art.

Further, the fluorescence amplifier device using surface plasmon resonance according to an embodiment of the inventive concept may reduce the generated noise using a filter.

The light amplifier device using surface plasmon resonance according to an embodiment of the inventive concept amplifies the fluorescent light generated from the fluorescent material such that a measurement sensor can measure amount of the fluorescent light more than the conventional art.

Further, the light amplifier device using surface plasmon resonance according to an embodiment of the inventive concept may reduce the generated noise using a filter.

### BRIEF DESCRIPTION OF THE DRAWINGS

FIG. 1 is a drawing illustrating a construction of a fluorescence amplifier device using surface plasmon resonance according to an embodiment of the inventive concept;

FIGS. 2A to 2D are a drawing illustrating various constructions of a fluorescence amplifier unit of a fluorescence amplifier device using surface plasmon resonance according to an embodiment of the inventive concept;

FIGS. 3A and 3B are a drawing illustrating various experiment results of a fluorescence amplifier device using surface plasmon resonance according to an embodiment of the inventive concept;

FIGS. 4A and 4B are a drawing illustrating construction of an L-mode(a) and a P-mode(b) of a light amplifier device using surface plasmon resonance according to an embodiment of the inventive concept;

FIG. 5 is a drawing schematically illustrating an amplifier unit of a fluorescence amplifier device using surface plasmon resonance according to an embodiment of the inventive concept;

FIG. 6 is a drawing schematically illustrating a process coupling a secondary antibody with the amplifier unit of a light amplifier device using surface plasmon resonance according to an embodiment of the inventive concept; and

FIGS. 7A to 7D are a drawing illustrating various experiment results of a light amplifier device using surface plasmon resonance according to an embodiment of the inventive concept;

### DETAILED DESCRIPTION OF THE EMBODIMENTS

Embodiments of the inventive concept will be described more fully hereinafter with reference to the accompanying drawings and let those skilled in the art implement easily. The inventive concept may be implemented in various forms and not limited to the following embodiments. Embodiments of the inventive concept are not limited to the specific shape illustrated in the drawings, but for describing the inventive concept obviously, may include other shape not related to description. The same reference numerals or the same reference designators denote the same elements throughout the specification.

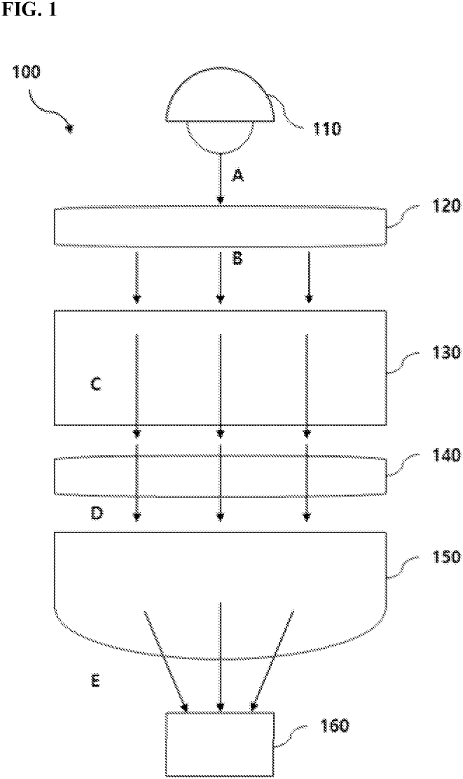

FIG. 1 is a drawing illustrating a construction of a fluorescence amplifier device using surface plasmon resonance according to an embodiment of the inventive concept. Referring to FIG. 1, a fluorescence amplifier device 100 using surface plasmon resonance according to the inventive concept may be formed to include a light source 110, a first filter unit 120, a fluorescence amplifier unit 130, a second filter unit 140, a lens unit 150 and a measurement unit 160.

The light source 110 may be formed to generate a first light and emit it to the first filter unit 120 (A). The light source 110 may be formed of a LED to generate a first light, and the first light may be a visible light of blue series with mean value of 470 nm.

The first filter unit 120 may be formed to receive a first light and remove a noise. The first filter unit 120 may be consisted below the light source 110 in a traveling direction of the first light, and formed to remove a first noise contained in the first light while the first light transmits through the first filter unit 120.

Though the light source 110 generates the first light of light series visible light with 470 nm, the first light may not be a single wavelength of 470 nm and contain noises of various wavelengths. Since these noises may affect when the following fluorescence amplifier unit 130 generates a fluorescent light, the first light with a minimum noise should be moved to the fluorescence amplifier unit 130.

Thus, the first filter unit 120 may be formed of a filter capable of transmitting only light of 460 nm to 480 nm in order to remove a first noise with an error over 10 nm in basis of 470 nm which is the mean value of the first light.

The noise may be removed while the first light transmits the first filter unit 120 and the blue series light of the wavelength of 460 nm to 480 nm may be incident to the fluorescence amplifier unit 130 (B).

The fluorescence amplifier unit 130 may be consisted under the filter unit 120 in traveling direction of the first light. The fluorescence amplifier unit 130 may receive the first light to generate a fluorescent light that is a second light, and be formed to amplify the second light using surface plasmon resonance effect (C). The fluorescence amplifier unit 130 may transform the first light of the blue series with the mean wavelength value of 470 nm to the second light of a green series with mean wavelength value of 525 nm.

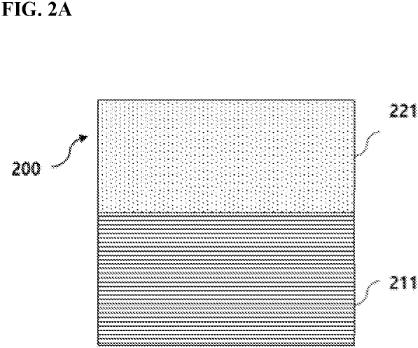

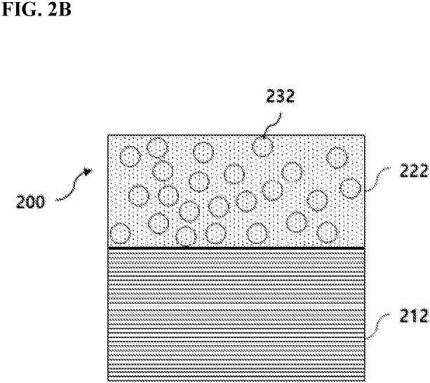

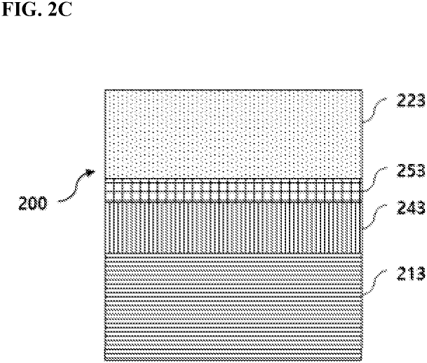

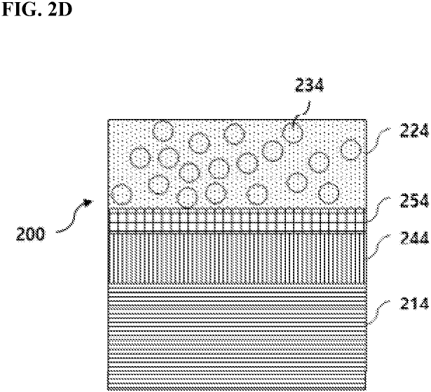

Achieving the above, the fluorescence amplifier unit 130 may use interior components which will be illustrated hereinafter in FIGS. 2A to 2D.

the second filter unit 140 may be consisted under the fluorescence amplifier unit 130 in a traveling direction of the second light and formed to receive the second light and remove a noise. The second filter unit 140 may be formed to remove the noise contained in the second light when the second light transmits through the second filter unit 140.

Though the fluorescence amplifier unit 130 generates the second light of green series visible light with mean wavelength value of 525 nm using the first light, the second light may not have a single wavelength of 525 nm but contain noises of various wavelengths. Since these noises may affect when the following measurement unit 160 generates a fluorescent light, the second light with a minimum noise should be moved to the measurement unit 160.

Thus, the second filter unit 140 may be formed of a filter capable of transmitting only light from 515 nm to 535 nm in order to remove a second noise with an error over 10 nm in basis of 525 nm which is the mean value of the second light.

The noise may be removed while the second light transmits the second filter unit 140 and the blue series light of the wavelength of 515 nm to 535 nm may be incident to the lens unit 150 (D).

The lens unit 150 may be formed to receive a second light and collect the second light toward a focus direction. The lens unit 150 may be consisted under the second filter unit 140 in the direction of the second light for achieving the above and formed of a compound lens or an aspherical convex lens of which a surface is convex shape.

The second light incidents to the other surface of the lens unit 150 may be concentrated toward the focus since a path of the second light changes toward to focus direction while penetrating the lens unit.

Finally, the measurement unit 160 may be formed to receive the second light and measure amount of fluorescent light. For achieving the above, the measurement unit 160 may be consisted under the lens unit 180 in the traveling direction of the second light, and formed near the focus of the lens unit 150 to obtain the maximum amount of the second light after transmitting the lens unit 150.

Meanwhile, FIGS. 2A to 2D illustrates constructions of the fluorescence amplifier unit according to an embodiment of the inventive concept. FIG. 2A shows a basic component of the fluorescence amplifier unit which includes a dielectric layer, nonconducting layer and fluorescent layer, and FIGS. 2B to 2D show other embodiments of the fluorescence amplifier unit which is changed from the FIG. 2A in order to compare experiments.

Results of the experiments will be described hereinafter in order to obtain an optimum fluorescence amplifier unit capable of maximizing effect of the fluorescence amplifier unit from the four embodiments of the fluorescence amplifier unit.

FIG. 2A shows the fluorescence amplifier unit including the dielectric layer and fluorescent layer, FIG. 2B shows the fluorescence amplifier unit formed of the dielectric layer, the fluorescent layer and sliver nanoparticle contained in the fluorescent layer, FIG. 2C shows the fluorescence amplifier unit including the dielectric layer, a metal layer, the nonconducting layer, the fluorescent layer and the silver nanoparticle contained in the fluorescent layer.

Dielectric constants of materials consisting the fluorescence amplifier unit 130 in the experiment may be provided in the following TABLE 1.

TABLE 1

| Material | Dielectric Constance | |
|---|---|---|
| Material | 470 nm | 520 nm |
| Silver (Ag, Metal layer) | -8.2568+0.23408i | -11.168+0.28323i |
| Magnesium fluoride (MgF₂, Nonconducting layer) | 2.0312 | 2.0266 |
| Silicon (SiO₂, Fluorescent layer) | 2.1609 | 2.1533 |
| Glass (Soda Lime Glass-clear, Dielectric layer) | 2.3415 | 2.3311 |

In the experiments, FIG. 2A shows a Non-SPCE structure without generating surface plasmon resonance, FIG. 2B shows a LSPR (Local Surface Plasmon Resonance) structure generating local surface plasmon resonance, FIG. 2C shows a SPCE structure generating only surface plasmon resonance, and FIG. 2D shows a LSPR+SPCE structure generating both of surface plasmon resonance and local surface plasmon resonance. Considering FIG. 2A, the fluorescence amplifier unit 130 includes the dielectric layer 211 and the fluorescent layer 221. The fluorescent layer 221 may be formed on the dielectric layer 211 by a spin coating.

The fluorescent layer 221 may receive a first light incident from an upside and form the second light of fluorescent light to emit the second light downward. The emitted second light may transmit the dielectric layer 211 for forming the fluorescent layer 221 and get out of the fluorescence amplifier unit 130.

Since FIG. 2A does not show any particular amplification structure in this process, intensity of the second light may be determined depending on fluorescence efficiency of the fluorescence in the fluorescent layer 221.

Next, considering FIG. 2B, FIG. 2B shows the fluorescence amplifier unit 130 including the dielectric layer 212, the fluorescent layer 222 and the silver nanoparticle 232 contained in the fluorescent layer 222. FIG. 2B is a structure containing the silver nanoparticle 232 in the fluorescent layer 222 of FIG. 2A. The fluorescent layer 232 and the silver nanoparticle 232 may be formed on the dielectric layer 212 by the spin coating. The silver nanoparticle may be distributed uniformly in the fluorescent layer 222 by the spin coating.

The fluorescent layer 222 may receive a first light incident upward and form the second light of fluorescent light to emit the second light downward. The emitted second light may transmit the dielectric layer 212 for forming the fluorescent layer 222 and get out of the fluorescence amplifier unit 130.

The silver nanoparticle 232 contained in the fluorescent layer 222 may generate the second light amplified using local surface plasmon resonance.

The silver nanoparticle 232 may be vibrated caused by receiving light while the light pass through the fluorescent layer 222, and the vibration of the silver nanoparticle 232 generates powerful electric field with a radius of 30 nm.

The silver nanoparticle 232 may emit scattered light of 470 nm during the vibration process, and the fluorescent layer 222 may generate the second light which is a fluorescent light amplified using the scattered light as well as the first light.

The generated second light may transmit the dielectric layer 212 through a bottom of the fluorescent layer 222 to get out of the fluorescence amplifier unit 130. Since FIG. 2A may use the scattered light generated in the vibration process of the silver nanoparticle 232 in this process, comparing with FIG. 2A, the second light with light amount more than FIG. 2A can be emitted.

Next, considering FIG. 2C, FIG. 2C shows the fluorescence amplifier unit 130 including the dielectric layer 213, the metal layer 243, the nonconducting layer 253 and the fluorescent layer 223. The fluorescent layer 223 may be formed on the nonconducting layer 253 by the spin coating.

The fluorescent layer 223 may receive the first light on its upper side, generate the second light which is amplified fluorescent light from the first light by the SPCE structure using the nonconducting layer 253 formed under the fluorescent layer 223 and the fluorescent layer formed under the nonconducting layer 253, emit the second light through a bottom side.

This structure may let the nonconducting layer 253 and the fluorescent layer 223 perform as light waveguide part which can generate surface plasmon resonance.

Finally, considering FIG. 2D, FIG. 2D shows the fluorescence amplifier unit 130 including the dielectric layer 214, the metal layer 244, the nonconducting layer 254, fluorescent layer 224 and the silver nanoparticle 234 contained in the fluorescent layer 224.

FIG. 2D is a structure containing the silver nanoparticle 234 in the fluorescent layer 223 of FIG. 2C. The fluorescent layer 224 and the silver nanoparticle 234 may be formed on the dielectric layer 214 by the spin coating. The silver nanoparticle 234 may be distribute uniformly in the fluorescent layer 224 by the spin coating.

The fluorescent layer 224 may receive a first light incident into its upper side and form the second light of fluorescent light to emit the second light downward. The emitted second light may transmit the dielectric layer 214 for forming the fluorescent layer 224 and get out of the fluorescence amplifier unit 130.

The silver nanoparticle 234 contained in the fluorescent layer 224 may generate the second light amplified using local surface plasmon resonance.

The silver nanoparticle 234 may be vibrated caused by receiving light while the light pass through the fluorescent layer 224, and the vibration of the silver nanoparticle 234 generates powerful electric field with a radius of 30 nm.

The silver nanoparticle 234 may emit scattered light of 470 nm during the vibration process, and the fluorescent layer 224 may generate the second light of amplified fluorescent light as well as the first light using the scattered light in addition.

Meanwhile, the fluorescent layer 224 may generate the second light which is amplified fluorescent light from the first light by the SPCE structure using the nonconducting layer 254 formed under the fluorescent layer 224 and the fluorescent layer formed under the nonconducting layer 254, emit the second light through a bottom side.

This structure may let the nonconducting layer 254 and the fluorescent layer 224 perform as light waveguide part which can generate surface plasmon resonance.

The fluorescence amplifier unit 130 shown in FIG. 2D, in comparison with the Non-SPCE in FIG. 2A, the LSPR in FIG. 2B, the SPCE in FIG. 2C, generates the second light of amplified fluorescent light using both of surface plasmon resonance and local surface plasmon resonance, thereby providing amount of fluorescent light more than the fluorescence amplifier unit 130 of FIGS. 2A to 2C.

Meanwhile, thickness of the light waveguide should be determined to meet condition in order to use maximum efficiency of surface plasmon resonance (SPCE). Accordingly, an experiment was further performed to confirm efficiency of the structures in FIGS. 2A to 2D and efficiency of each structure depending on thickness.

The following TABLEs 2 to 5 is result of the experiment obtaining enhancement factor and optical efficiency of the fluorescence amplifier unit of FIGS. 2A to 2D when contents of SiO2 contained in each fluorescent substance are 20%, 30%, 40%, 50%.

TABLE 2

| | | |
|---|---|---|
| Normal (FIG. 2a ) | Effective Power [nW] | 53.75313 |
| | SD [nW] | 0.01635 |
| LSPR (FIG. 2b ) | Effective Power [nW] | 245.49847 |
| | SD [nW] | 0.06126 |
| SPCE (FIG. 2c ) | Effective Power [nW] | 283.11511 |
| | SD [nW] | 0.06126 |
| LSPR+SPCE (FIG. 2d ) | Effective Power [nW] | 304.30666 |
| | SD [nW] | 0.33565 |
| Amplification Factor | LSPR/Normal | 4.56715 |
| | SPCE/Normal | 5.26695 |
| | (LSPR+SPCE)/Normal | 5.66119 |

TABLE 2 is a result of the experiment using the fluorescence amplifier unit in which SiO2 content of the fluorescent substance was 20% and thickness was 140.7 nm.

TABLE 3

| | | |
|---|---|---|
| Normal (FIG. 2a ) | Effective Power [nW] | 61.7113 |
| | SD [nW] | 0.01601 |
| LSPR (FIG. 2b ) | Effective Power [nW] | 252.27913 |
| | SD [nW] | 0.06021 |
| SPCE (FIG. 2c ) | Effective Power [nW] | 217.47111 |
| | SD [nW] | 0.06021 |
| LSPR+SPCE (FIG. 2d ) | Effective Power [nW] | 428.96168 |
| | SD [nW] | 0.09577 |
| Amplification Factor | LSPR/Normal | 408805 |
| | SPCE/Normal | 3.52401 |
| | (LSPR+SPCE)/Normal | 6.9511 |

TABLE 3 is a result of the experiment using the fluorescence amplifier unit in which SiO2 content of the fluorescent substance was 30% and thickness was 159.4 nm.

TABLE 4

| | | |
|---|---|---|
| Normal (FIG. 2a ) | Effective Power [nW] | 67.3363 |
| | SD [nW] | 0.02221 |
| LSPR (FIG. 2b ) | Effective Power [nW] | 263.3073 |
| | SD [nW] | 0.04044 |
| SPCE (FIG. 2c ) | Effective Power [nW] | 2099.26483 |
| | SD [nW] | 0.04044 |
| LSPR+SPCE (FIG. 2d ) | Effective Power [nW] | 7676.9583 |
| | SD [nW] | 0.06673 |
| Amplification Factor | LSPR/Normal | 3.91033 |
| | SPCE/Normal | 31.17583 |
| | (LSPR+SPCE)/Normal | 114.00921 |

TABLE 4 is a result of the experiment using the fluorescence amplifier unit in which SiO2 content of the fluorescent substance was 40% and thickness was 198.6 nm.

TABLE 5

| | | |
|---|---|---|
| Normal [FIG. 2a ] | Effective Power [nW] | 66.14673 |
| | SD [nW] | 0.02425 |
| LSPR (FIG. 2b ) | Effective Power [nW] | 281.61357 |
| | SD [nW] | 0.04059 |
| SPCE (FIG. 2c ) | Effective Power [nW] | 1790.52391 |
| | SD [nW] | 0.04059 |
| LSPR+SPCE (FIG. 2d ) | Effective Power [nW] | 5001.89344 |
| | SD [nW] | 0.083 |
| Amplification Factor | LSPR/Normal | 4.25741 |
| (Enhancement factor) | SPCE/Normal | 27.06897 |
| | (LSPR+SPCE)/Normal | 75.61815 |

TABLE 5 is a result of an experiment using the fluorescence amplifier unit in which SiO2 content of the fluorescent substance was 50% and thickness is 259.3 nm. Considering results of the experiments of TABLEs 2 to 5, concentration of the fluorescent substance is gradually decreased at 80%, 70%, 60% and 50% but effective power is not decreased even if the concentration of the fluorescent substance was decreased. Therefore, the concentration of the fluorescent substance in the results of the experiments is determined that is not enough critical factor to affect changing of the effective power.

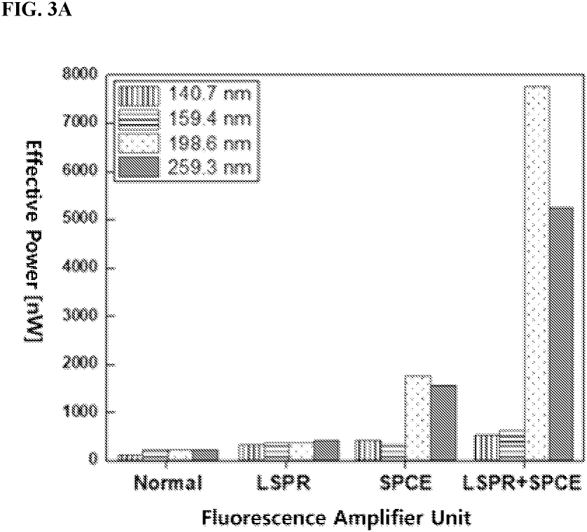

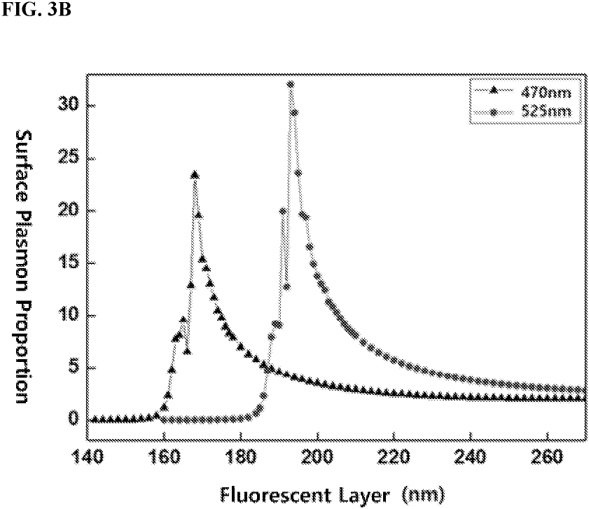

Meanwhile, in the results of the experiments of the TABLEs 2 to 5, the thickness of the fluorescent layers was increased at 140.7 nm, 159.4 nm, 198.6 nm and 259.3 nm. FIG. 3 is a graph showing the result of experiment according to these thickness increment.

Referring to FIGS. 3A AND 3B, the result of the experiment does not teach difference of effective power related to thickness in the Non-SCPE structure of FIG. 2A, but teaches that the effective power is increased as increasing the thickness in the LSPR structure of FIG. 2B.

Further, in the SPCE structure of FIG. 2C, the experiments of TABLEs 4 and 5 in comparison with the experiments of TABLEs 2 and 4 show that the effective power is significantly increased. Further, the effective power is increased at a large step in the LSPR+SPCE structure of FIG. 2D in comparison’ with the structure of FIG. 2C.

Meanwhile, considering FIG. 3A, it is confirmed that both of the SPCE structure and the LSPR+SPCE structure record high effective power in the fluorescent layer with thickness of 198.6 nm in comparison with the fluorescent layer with thickness of 259.3 nm.

FIG. 3B is a drawing illustrating a resonance ratio related to the thickness of the fluorescent layer. The resonance ratio is a value proportion to a Q-factor (Quality factor) of surface plasmon resonance, means a ratio capable of generating surface plasmon resonance and means that the surface plasmon resonance may be more generated easily as the resonance ratio is increasing.

Referring to FIGS. 3A and 3B, in the inventive concepts, the surface plasmon resonance of the first light with 470 nm is increased over 160 nm of the thickness of the fluorescent layer, records a peak around 170 nm and is decreased, and is saturated after 200 nm and maintained.

Further the surface plasmon resonance of the second light with 525 nm is rapidly increased over 180 nm of the thickness of the fluorescent layer and shows a peak around 195 nm, and then is decreased and saturated at a constant value over 240 nm.

According to these results, the thickness of the light waveguide should be accepted to specific multiple condition capable of generating surface plasmon resonance in order to generate the surface plasmon resonance effectively. It is confirmed that the LSPR+SPCE structure of the inventive concept can be expected the highest surface plasmon resonance effect when the thickness of the fluorescent layer is from 160 nm to 200 nm, in the basis of the result of the experiment of FIG. 3B.

Accordingly, the best mode of the fluorescence amplifier unit of the inventive concept may have the LSPR+SPCE structure of FIG. 2D and the fluorescent layer 224 with thickness from 170 nm to 240 nm simultaneously.

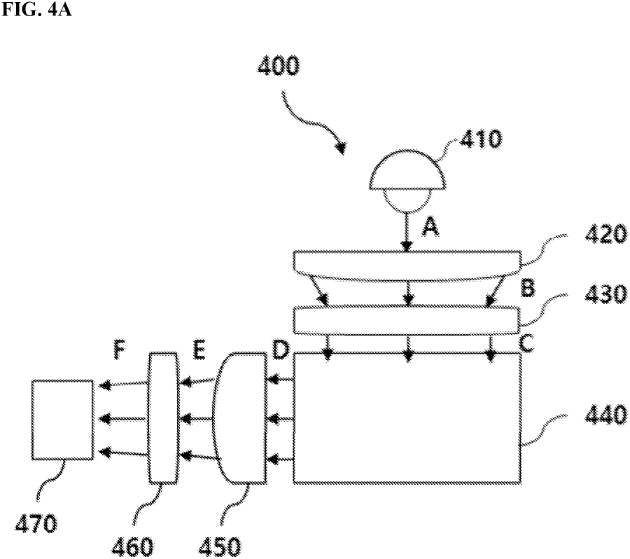

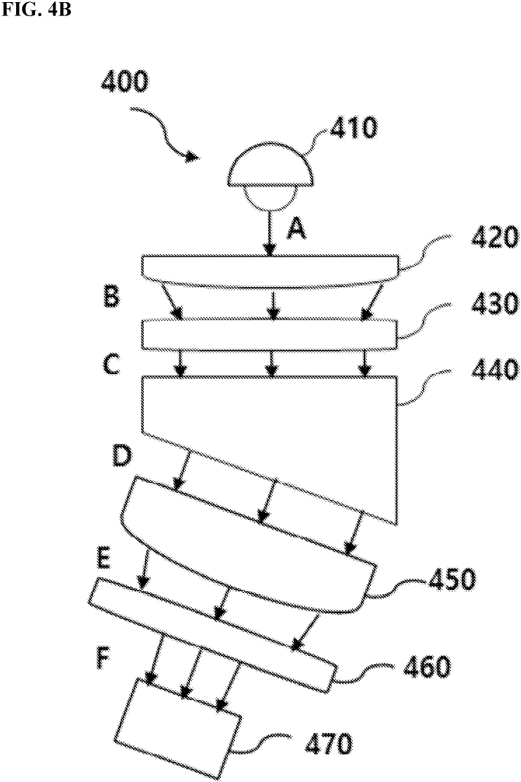

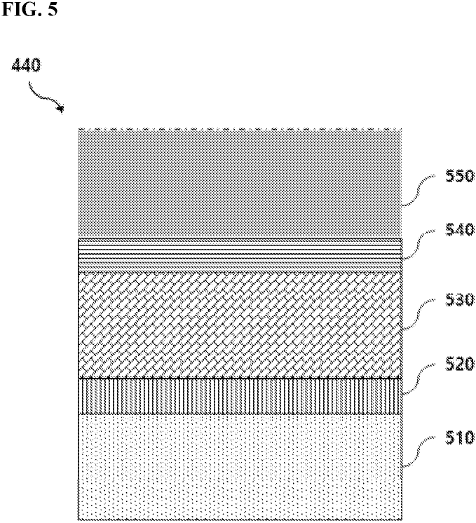

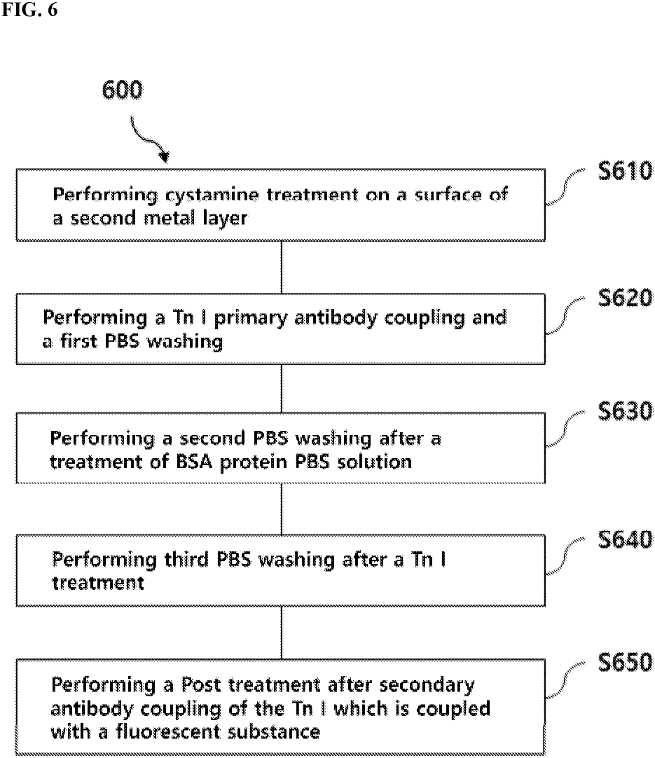

FIGS. 4A and 4B are a drawing illustrating constructions of an L-mode(a) and a P-mode(b) of a light amplifier device using surface plasmon resonance according to an embodiment of the inventive concept, FIG. 5 is a drawing schematically illustrating an amplifier unit of a fluorescence amplifier device using surface plasmon resonance according to an embodiment of the inventive concept, and FIG. 6 is a drawing schematically illustrating a process coupling a secondary antibody with the amplifier unit of a light amplifier device using surface plasmon resonance according to an embodiment of the inventive concept.

A light amplifier device using surface plasmon resonance according to an embodiment of the inventive concept will be described hereinafter with reference to FIGS. 4A to 6.

Referring to FIGS. 4A and 4B, a light amplifier device using surface plasmon resonance according to an embodiment of the inventive concept may be formed of an L-mode(a) or a P-mode(b).

Referring to FIG. 1, a light amplifier device 400 using surface plasmon resonance according to the inventive concept may be formed to include a light source 410, a first lens unit 420, a first filter unit 430, an amplifier unit 440, a second lens unit 450, a second filter unit 460, and a measurement unit 470.

The light source 410 may be formed to emit a first light in a direction (A). The first light may be a visible light of blue series with mean wavelength value of 470 nm, and the light source 410 may be formed of a blue LED.

The first lens unit 420 may be formed below the light source 410. The first lens unit 420 may be formed to collect the first light emitted from the light source 410, and formed of a collimate lens of which a side is formed in convex shape to collect the first light to the focus direction of the first lens unit 420.

The first filter unit 430 may be formed below the first lens unit 420. The first filter unit 430 may be formed to receive the first light transmitting the first lens unit 420 and being collected in the focus direction of the first lens unit 420. The first filter unit 430 may remove a noise.

The first filter unit 430 may be formed to remove the noise contained in the first light when the first light transmits through the first filter unit 430.

Though the light source 410 generates the first light of light series visible light with 470 nm, the first light may not be a single wavelength of 470 nm and contain noises of various wavelengths. Since these noises may affect to generation of a fluorescent light by the following amplifier unit 440, the first light with a minimum noise should be moved to the amplifier unit 440.

Thus, the first filter unit 430 may be formed of a filter capable of transmitting only light from 450 nm to 490 nm in order to remove a first noise with an error over 20 nm in basis of 470 nm which is the mean value of the first light.

In other words, the first filter unit 430 may pass the wavelength from 450 nm to 490 nm in the first light and filter other range of the wavelength by determining as a first noise.

The noise may be removed while the first light transmits the first filter unit 430 and the blue series light with the wavelength of 450 nm to 490 nm may be incident to the amplifier unit 440 (B).

The amplifier unit 440 may be consisted under the first filter unit 430 in traveling direction of the first light. The amplifier unit 130 may receive the first light of which the first noise was removed to generate a fluorescent light that is a second light, and be formed to amplify the second light using surface plasmon resonance effect (D). The amplifier unit 130 may transform the first light of the blue series with the mean wavelength value of 470 nm to the second light of a green series with mean wavelength value of 525 nm.

In order to the above, the amplifier unit 440 may use construction shown in FIG. 5.

Referring to FIG. 5, the amplifier unit 440 according to an embodiment of the inventive concept may be formed of a dielectric layer 510, a first plated layer 520, a light waveguide layer 530, a second plated layer 540 and a fluorescent layer 550.

The dielectric layer 510 may be consisted as a base for forming form the first plated layer 520 through the fluorescent layer 550. In this case, the dielectric layer 510 may be formed of a material with refractive index from 1.45 through 1.55.

The first plated layer 520 may be formed on the dielectric layer 510, the light waveguide layer 530 may be formed on the first plated layer 520, the second plated layer 540 may be formed on the light waveguide layer 530, and the fluorescent layer 550 may be formed to couple on the second plated layer 540.

By this structure, the amplifier unit 440 may receive the first light to transmit through the fluorescent layer 550, generate a second light with a different mean wavelength value, generate surface plasmon effect using the light waveguide layer 530 formed between the first plated layer 520 and the second plated layer 540 to amplify the second light generated while passing the fluorescent layer 550.

In this case of the amplifier unit 440, the dielectric layer may be formed of glass, the first plated layer 520 may be formed of chrome, the light waveguide layer 530 may be formed of silver and the second plated layer 540 may be formed of gold.

In order to amplifying the second light with high efficiency, the first plated layer 520 may be formed at around 2 nm, the light waveguide layer 530 may be formed at around 50 nm, and the second plated layer 540 may be formed at around 2 nm.

The fluorescent layer 550 may be formed to couple on the second plated layer 540. The fluorescent layer 550 may be formed by coupling a secondary antibody on the second plated layer 540. The secondary antibody is a second antibody of Troponin I (Tn I) containing a fluorescent substance.

FIG. 6. illustrate a brief sequence for forming the fluorescent layer 550. Referring to FIG. 6, the fluorescent layer according to an embodiment of the inventive concept may be generated using a step S610 of performing a cystamine treatment to a surface of the second plated layer, a step S620 of coupling a primary antibody of the Troponin I and performing a first PBS washing, a step S530 of performing a second PBS washing after treating in PBS which contains BSA protein with a predetermined concentration, a step S640 of performing a Troponin I treatment and a third PBS washing, and a step S650 of coupling a secondary antibody of the Troponin I which is coupled with the fluorescent substance and performing a post treatment.

In order to forming another fluorescent layer according to an embodiment of the inventive concept, in the step of S610, the cystamine treatment is performed on the second plated layer for 2 hours to form a branch S-NH2 for connecting to the second plated layer. And then, in the step of S620, the primary antibody of the Tn I may be treated at 4° C. for 90 minutes and the first PBS washing may be performed to couple the primary antibody with the NH2 which is formed on an end of the branch.

In the next, in step S630, the second plated layer may be formed by performing the second PBS washing after treating in the PBS solution which contains a BSA protein with concentration of 3% for 15 minutes to deposit the BSA protein on the surface of the second plated layer, and in step S640, performing the Tn I treatment for 30 minutes and the third PBS washing to couple the Tn I with the primary antibody.

Finally, for the amplifier unit, the second antibody of Tn I coupled with the fluorescent substance by cultivation at 37° C. for 1 hour is coupled with the Tn I to form the fluorescent layer, and a fourth PBS washing and a drying at 37° C. for 15 minutes are performed in the step S650.

According to these steps, the amplifier unit may be formed the fluorescent layer on the second plated layer. The fluorescent layer may be formed of a fluorescent material which is named to Alexa-488. Thus, the fluorescent layer can change the first light of the blue series with the mean wavelength value of 470 nm to the second light of the green series with the mean wavelength value of 525 nm.

According to the above constructions of FIG. 5 and FIG. 6, the amplifier unit 440 according to an embodiment of the inventive concept may be formed to receive the first light to generate the second light which was amplified.

Meanwhile, the light amplifier device using surface plasmon resonance according to an embodiment of the inventive concept may be formed in the L-mode(a) or the P-mode(b) as described in FIGS. 4A and 4B.

The L-mode shown in FIG. 4A is a mode in which the second lens unit 450, the second filter unit 460 and the measurement unit 470 are formed beside laterally beside the amplifier unit 440, and the P-mode shown in FIG. 4B is a mode in which a prism is formed on the bottom surface of the amplifier unit 440 and the second lens unit 450, the second filter unit 460 and the measurement unit 470 are formed beside an oblique plane of the prism.

The second lens 450 may be formed on the side of the amplifier unit 440 in the L-mode and formed on the oblique plane of the amplifier unit 440. 2 The lens unit 450 may be formed to receive a second light and collect the second light toward a focus direction.

In order to the above, the lens unit 450 may be formed of a compound lens or an aspherical convex lens of which a side is convex shape), the second light D incident to the second lens 450 may change their traveling direction toward the focus direction of the second lens 450 to focus each other while transmitting the second lens unit 450.

the second filter unit 460 may be consisted in the focus direction of the second lens unit 460 that is the traveling direction of the second light, and formed to receive a second light and remove a noise. The second filter unit 460 may be formed to remove the noise contained in the second light when the second light transmits through the second filter unit 460.

Though the light amplifier unit 440 generates the second light of green series visible light with mean wavelength value of 525 nm using the first light, the second light may not have a single wavelength of 525 nm but contain noises of various wavelengths. Since these noises may affect to generation of a fluorescent light by the following measurement unit 470, the second light with a minimum noise should be moved to the measurement unit 470.

Thus, the second filter unit 460 may be formed of a filter capable of transmitting only light from 500 nm to 550 nm in order to remove a second noise with an error over 25 nm in basis of 525 nm which is the mean value of the second light.

The noise may be removed while the second light transmits the second filter unit 460 and the blue series light of the wavelength from 500 nm to 550 nm may be incident to the measurement unit 470 (F).

Finally, the measurement unit 470 may be formed to receive the second light and measure amount of fluorescent light. In order to the above, the measurement unit 470 may be consisted on the side of the second filter unit 460 which is the traveling direction of the second light.

Meanwhile, the light amplifier device 400 using surface plasmon resonance according to an embodiment of the inventive concept may achieve the same operation or the same result even if the first lens unit 420 and the first filter unit 430 are consisted by changing their order or the second lens unit 450 and the second filter unit460 are consisted by changing their order, thus the order is not limited in the embodiments.

In addition, the light amplifier device 400 using surface plasmon resonance according to an embodiment of the inventive concept may use immersion oil in order to couple the prism on the bottom of the amplifier unit 440, and may be formed to include further a ND filter on the entire surface of the measurement unit 470.

Further, the light amplifier device 400 using surface plasmon resonance according to an embodiment of the inventive concept may be further formed a silicon additive (Polydimethylsiloxane, PDMS) shaped in a plurality of pyramids under the dielectric layer 510.

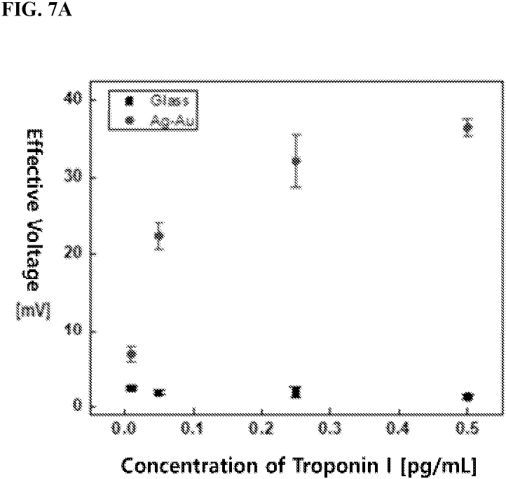

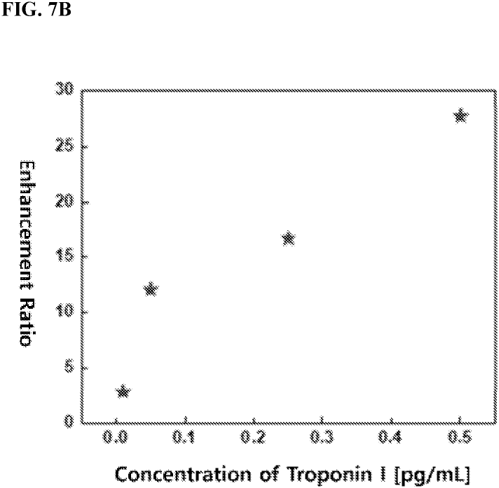

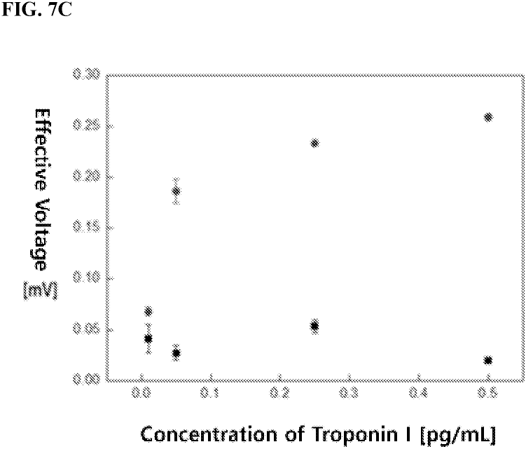

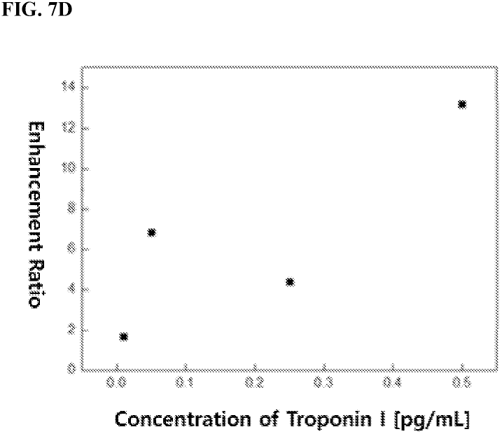

FIGS. 7A to 7D show an experiment result of comparing the final detection quantity of light between the light amplifier device using surface plasmon resonance according to the embodiment of the inventive concept and the conventional device measuring the fluorescent light using without surface plasmon resonance.

The following TABLE 6 is a result of a simulation experiment of using surface plasmon resonance in L-mode or not, and the following TABLE 7 is a result of a simulation experiment of using surface plasmon resonance in P-mode or not.

TABLE 6

L-mode, LED 100 mA, Voltage 0.5 V, Filter 2.0 OD

| Tn I concentration [pg/mL] | Non-SPCE | | SPCE | | Enhancement ratio [S/NS] |
|---|---|---|---|---|---|
| Tn I concentration [pg/mL] | Effective voltage [mV] | SD [mV] | Effective voltage [mV] | SD [mV] | Enhancement ratio [S/NS] |
| 0.01 | 2.4267 | 0.16182 | 6.91903 | 1.03380 | 2.851210 |
| 0.05 | 1.85052 | 0.28216 | 22.33841 | 1.64855 | 12.07144 |
| 0.25 | 1.92905 | 0.72629 | 32.21718 | 3.45711 | 16.70106 |
| 0.50 | 1.31687 | 0.27930 | 36.44144 | 1.15219 | 27.67284 |

TABLE 7

P-mode, LED 100 mA, Voltage 0.5 V, Filter 2.0 OD

| Tn I concentration [pg/mL] | Non-SPCE | | SPCE | | Enhancement ratio [S/NS] |
|---|---|---|---|---|---|
| Tn I concentration [pg/mL] | Effective voltage [mV] | SD [mV] | Effective voltage [mV] | SD [mV] | Enhancement ratio [S/NS] |
| 0.01 | 0.04108 | 0.00140 | 0.06803 | 0.000451 | 1.65588 |
| 0.05 | 0.02724 | 0.00725 | 0.18656 | 0.01157 | 6.84988 |
| 0.25 | 0.05347 | 0.00628 | 0.23374 | 0.00280 | 4.37155 |
| 0.50 | 0.01965 | 0.00133 | 0.25864 | 0.00219 | 13.16568 |

Considering TABLE 6 and TABLE 7, the present simulation experiment implemented by setting the concentration of the Tn I was 0.01, 0.05, 0.25 and 0.50 pg/mL, respectively. For each concentration, 10 times measurement was performed using the Non-SPCE structure (hereinafter, NS) with surface plasmon resonance and the SPCE structure (the embodiment of the inventive concept, S hereinafter). And, in the present simulation experiment, the current supplied to the light source 410 was fixed at 400 mA, the voltage was fixed at 0.5 V, and a filter as the ND filter had 2.0 OD. Considering TABLE 6 and FIG. 7A, the amount of light for each concentration was detected not over 2.5 mV such as 2.4267, 1.85052, 1.92905 and 1.31687 mV when the Tn I was detected using the NS structure of the L-mode in the present simulation experiment.

When the Tn I was detected using the S structure according to the embodiment of the inventive concept, the amount of light for each concentration was detected from 7 mV through 36 mV such as 6.91903, 22.33841, 32.21718 and 36.44144 mV.

Through the simulation experiment, there is difference per concentration in the L-mode, however, it is confirmed, as shown in TABLE 6 and FIG. 7B, that the S-structure shows enhancement ration from minimum 2.85 times to maximum 27.68 times in comparison with the NS structure.

Meanwhile, considering TABLE 7 and FIG. 7C, the amount of light for each concentration was detected not over 0.06 mV such as 0.04108, 0.02724, 0.05347 and 0.01965 mV when the Tn I was detected using the NS structure of the P-mode in the present simulation experiment.

When the Tn I was detected using the S structure according to the embodiment of the inventive concept, the amount of light for each concentration was detected from 0.068 mV through 0.26 mV such as 0.06803, 0.18656, 0.023374 and 0.25864 mV.

Through the simulation experiment, there is difference per concentration in the P-mode, however, it is confirmed, as shown in TABLE 7 and TABLE 7D, that the S-structure shows enhancement ration from 1.66 times to 13.17 times in comparison with the NS structure.

Summarizing the above-described simulation experiment, the light amplifier device using surface plasmon resonance according to the embodiment of the inventive concept shows significantly high acquisition quantity of fluorescent light in comparison with the conventional device without using surface plasmon resonance. This is the experiment result supports that the construction of the inventive concept has superior effect to comparison with the conventional art.

The embodiment of the inventive concept is described. It should be noted, however, that the inventive concept is not limited to the embodiments in the specifications, and may be implemented in various forms. Those skilled in the art who understands the inventive concept can suggest other embodiments by adding, modification, elimination and addition of a component. These, however, belong to scope of the inventive concept.
100: Fluorescence amplifier device using surface plasmon resonance
400: Light amplifier device using surface plasmon resonance
110,410: Light source
120,430: First filter unit
140,460: Second filter unit
130, 200: Fluorescence amplifier
440: Amplifier unit
150: Lens unit
420: First lens unit
450: Second lens unit
160,470: Measurement unit
211,212,213,214,510: Dielectric layer
221, 222, 223, 224: Fluorescent layer
550: Fluorescent layer
243,244: Plated layer
520: First plated unit
540: Second plated unit
253,254: Nonconducting layer
530: Light waveguide layer

What is claimed is:

1-16. (canceled)

17. A light amplifier device using surface plasmon resonance comprising:
a light source emitting a first light;
a first lens unit formed under the light source to collect the first light in an opposite direction from the light source;
a first filter unit formed under the first lens unit to remove a noise of the first light;
an amplifier unit receiving the first light and generating surface plasmon effect to generate a second light which is amplified light;
a second lens unit formed to collect the second light in a direction;
a second filter unit formed in a traveling direction of the second light which is transmit through the second lens unit, and consisted to remove a noise of the second light: and
a measurement unit formed in a traveling direction of the second light which is transmit through the second lens unit to measure intensity of the second light,
wherein the amplifier unit comprises,
a dielectric layer formed of glass;
a first plated layer formed of chrome on the dielectric layer;
a light waveguide formed of silver on the first plated layer;
a second plated layer formed of gold on the light waveguide; and
a fluorescent layer formed of a fluorescent substance contained in a material capable of coupling with the second plated layer, and
wherein the amplifier unit is formed in a L-mode depending on the traveling direction of the second light,
the traveling direction of the second light, in the L-mode, is a lateral direction of the amplifier unit,
and the second lens unit, the second filter unit and the measurement unit are formed sequentially in the lateral,
wherein the fluorescent layer is formed by coupling an antibody of Troponin I(Tn I) with the second plated layer over two times and coupling the Troponin I containing the fluorescent substance with a secondary antibody of the Troponin I.

18-20. (canceled)

21. The light amplifier device of claim 17, wherein the first plated layer is formed in around 2 nm., the light waveguide is formed in around 50 nm and the second plated layer is formed in around 2 nm.

22. The light amplifier device of claim 21, wherein the first light is emitted from the light source which is formed of a LED and has mean wavelength value of 470 nm, and the second light is emitted from the amplifier device and has mean wavelength value of 525 nm.

23. The light amplifier device of claim 22, wherein the filter unit is formed to decide the wavelength out of range of 450 nm to 490 nm from the first light as a first noise and removes the first noise.

24. The light amplifier device of claim 23, wherein the second unit is formed to decide the wavelength out of range of 500 nm to 550 nm from the second light as a first noise and removes the second noise.

25. The light amplifier device of claim 24, wherein the first lens unit is formed of a collimate lens of which a surface is formed in a convex surface to concentrate the first light at a focus point.

26. The light amplifier device of claim 25, wherein the second lens unit is formed of a convex lens to concentrate the second light to a direction.

27. The light amplifier device of claim 26, wherein further comprising: an aperture unit between the first filter unit and the amplifier unit to adjust light amount of the first light of which the first noise is removed.

28. The light amplifier device of claim 27, wherein further comprising an ND filter unit between the second filter unit and the measurement unit to filter collectively light amount of the second light of which the second noise is removed.

29. The light amplifier device of claim 28, wherein the amplifier further comprises a silicon additive layer (Polydimethylsiloxane, PDMS) under the dielectric layer, the silicon additive is formed in a plurality of pyramids which is formed using a material with dielectric constant between 1.35 and 1.45.

30. (canceled)

31. A light amplifier device using surface plasmon resonance comprising:
a light source emitting a first light;
a first lens unit formed under the light source to collect the first light in an opposite direction from the light source;
a first filter unit formed under the first lens unit to remove a noise of the first light;
an amplifier unit receiving the first light and generating surface plasmon effect to generate a second light which is amplified light;
a second lens unit formed to collect the second light in a direction;
a second filter unit formed in a traveling direction of the second light which is transmit through the second lens unit, and consisted to remove a noise of the second light: and
a measurement unit formed in a traveling direction of the second light which is transmit through the second lens unit to measure intensity of the second light,
wherein the amplifier unit comprises:
a dielectric layer formed of glass;
a first plated layer formed of chrome on the dielectric layer;
a light waveguide formed of silver on the first plated layer;
a second plated layer formed of gold on the light waveguide; and
a fluorescent layer formed of a fluorescent substance contained in a material capable of coupling with the second plated layer, and
wherein the amplifier unit is formed in a P-mode depending on the traveling direction of the second light,
another plane not an oblique plane of a prism, in a P-mode, is coupled with a bottom surface of the amplifier unit,
the traveling direction of the second light is a direction of the oblique surface, and
the second lens unit, the second filter unit and the measurement unit are formed sequentially in the direction of the oblique surface,
wherein the fluorescent layer is formed by coupling an antibody of Troponin I(Tn I) with the second plated layer over two times and coupling the Troponin I containing the fluorescent substance with a secondary antibody of the Troponin I.

32. The light amplifier device of claim 31, wherein the first plated layer is formed in around 2 nm., the light waveguide is formed in around 50 nm and the second plated layer is formed in around 2 nm.

33. The light amplifier device of claim 32, wherein the first light is emitted from the light source which is formed of a LED and has mean wavelength value of 470 nm, and the second light is emitted from the amplifier device and has mean wavelength value of 525 nm.

34. The light amplifier device of claim 33, wherein the filter unit is formed to decide the wavelength out of range of 450 nm to 490 nm from the first light as a first noise and removes the first noise.

35. The light amplifier device of claim 34, wherein the second unit is formed to decide the wavelength out of range of 500 nm to 550 nm from the second light as a first noise and removes the second noise.

36. The light amplifier device of claim 35, wherein the first lens unit is formed of a collimate lens of which a surface is formed in a convex surface to concentrate the first light at a focus point.

37. The light amplifier device of claim 36, wherein the second lens unit is formed of a convex lens to concentrate the second light to a direction.

38. The light amplifier device of claim 37, wherein further comprising: an aperture unit between the first filter unit and the amplifier unit to adjust light amount of the first light of which the first noise is removed.

39. The light amplifier device of claim 38, wherein further comprising an ND filter unit between the second filter unit and the measurement unit to filter collectively light amount of the second light of which the second noise is removed.

40. The light amplifier device of claim 39, wherein the amplifier further comprises a silicon additive layer (Polydimethylsiloxane, PDMS) under the dielectric layer, the silicon additive is formed in a plurality of pyramids which is formed using a material with dielectric constant between 1.35 and 1.45.
